(19) United States
(12) Patent Application Publication
(10) Pub. No.: US 2018/0260085 A1
(43) Pub. Date: Sep. 13, 2018

(54) AUTOFILL USER INTERFACE FOR MOBILE DEVICE

(71) Applicant: Google Inc., Mountain View, CA (US)

(72) Inventors: Casey Stuart WHITELAW, Paris (FR); Angela STRANGE, San Francisco, CA (US); James BLACKLER, London (GB); Yu CHEN, London (GB)

(73) Assignee: Google Inc., Mountain View, CA (US)

(21) Appl. No.: 14/042,448

(22) Filed: Sep. 30, 2013

(51) Int. Cl. G06F 3/0484

(52) U.S. Cl. CPC G06F 3/0484

(57) ABSTRACT

Systems and methods for providing an autofill user interface at a computing device are provided. In some aspects, a page is presented at the computing device, the page including one or more input boxes for entering input responsive to one or more prompts. One or more autofill suggestions for a first input box from the one or more input boxes are presented, where the one or more autofill suggestions are presented in a position overlaying the page, and where the page does not include the one or more autofill suggestions.

### BACKGROUND

The subject technology is generally directed to user interfaces for mobile devices.

Some web browsers running on laptop or desktop computers store user information (e.g., a user's name, address, payment information, etc.) locally at the client computing device to allow a user to “autofill” forms on web pages. Typically, when a user selects a first input box (e.g., a first name box) in a form, autofill suggestion(s) for the input box are presented in a dropdown menu. When the user hovers the mouse over one of the autofill suggestion(s), autofill suggestion(s) for the other fields (e.g., last name, address, etc.) corresponding to the selected autofill suggestion may be presented for the user's review. For example, a web browser on a desktop computer that is shared by a husband and a wife may store the wife's name coupled with the wife's business address and the husband's name coupled with the husband's home address. The user may then accept the autofill suggestion by clicking the mouse over the autofill suggestion in the dropdown menu.

### SUMMARY

In some aspects, the disclosed subject matter relates to a method, implemented at a computing device, for providing an autofill user interface at the computing device. The method includes presenting a page at the computing device, the page including one or more input boxes for entering input responsive to one or more prompts. The method includes presenting one or more autofill suggestions for a first input box from the one or more input boxes, where the one or more autofill suggestions are presented in a position overlaying the page, and where the page does not include the one or more autofill suggestions.

In some aspects, the disclosed subject matter relates to a non-transitory computer-readable medium encoded with executable instructions for providing an autofill user interface at the computer. The instructions include code for receiving a selection of a first input box from one or more input boxes presented in a page displayed via the computer. The instructions include code for presenting, responsive to the selection of the first input box, one or more autofill suggestions for the first input box, where the one or more autofill suggestions are presented in a position overlaying the page, and where the page does not include the one or more autofill suggestions.

In some aspects, the disclosed subject matter relates to a computing device. The computing device includes a touchscreen, one or more processors, and a memory. The memory includes instructions. The instructions include code for presenting a page at the touchscreen, the page including one or more input boxes for entering input responsive to one or more prompts. The instructions include code for receiving, via the touchscreen, a selection of a first input box from the one or more input boxes. The instructions include code for presenting at the touchscreen, responsive to the selection of the first input box, one or more autofill suggestions for the first input box, where the one or more autofill suggestions are presented in a position overlaying the page, and where the page does not include the one or more autofill suggestions.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIGS. 1A-1E illustrate mobile devices implementing an autofill user interface.

FIG. 2 illustrates, as a block diagram, an example of a mobile device for implementing an autofill user interface.

FIG. 3 illustrates an example process by which an autofill user interface for a mobile device may be implemented.

FIG. 4 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details. In some instances, certain structures and components are shown in block diagram form in order to avoid obscuring the concepts of the subject technology.

The scheme described above relies on the user being able to view an entire form on a single screen (which is typically a large screen of a laptop or desktop computer) in order to review the autofill suggestion(s) for all of the input boxes, and a distinction between hovering a mouse (to review the autofill suggestion(s)) and clicking the mouse (to select the autofill suggestion corresponding to the position of the mouse). While the above scheme may be used on a desktop or laptop computer which provides the large screen size and a mouse, the above scheme may not be useful on some mobile devices, for example, mobile phones or tablet computers that lack large screen sizes and rely on touchscreen input rather than mouse input. As the foregoing illustrates, a new approach for an autofill user interface for a mobile device may be desirable.

The subject technology provides an autofill user interface for a mobile device. As used herein, the term “autofill” may refer to a feature that automatically inserts information (e.g., first name, last name, street address, email address, telephone number, etc.) into an input box in a page. The page may be displayed in a web browser or in any other application, for example, a shopping application or a social networking application. The phrase “autofill suggestion” may refer to a suggestion for the automatically inserted information which may be accepted or rejected by the user. For example, if a computing device stores that the user's telephone number is 212-555-1234 and an input box for “telephone number” is presented in a page, an autofill suggestion of the text “212-555-1234” may be provided for the input box for “telephone number.” The user may accept or reject the suggestion to autofill the text “212-555-1234” into the input box for “telephone number.”

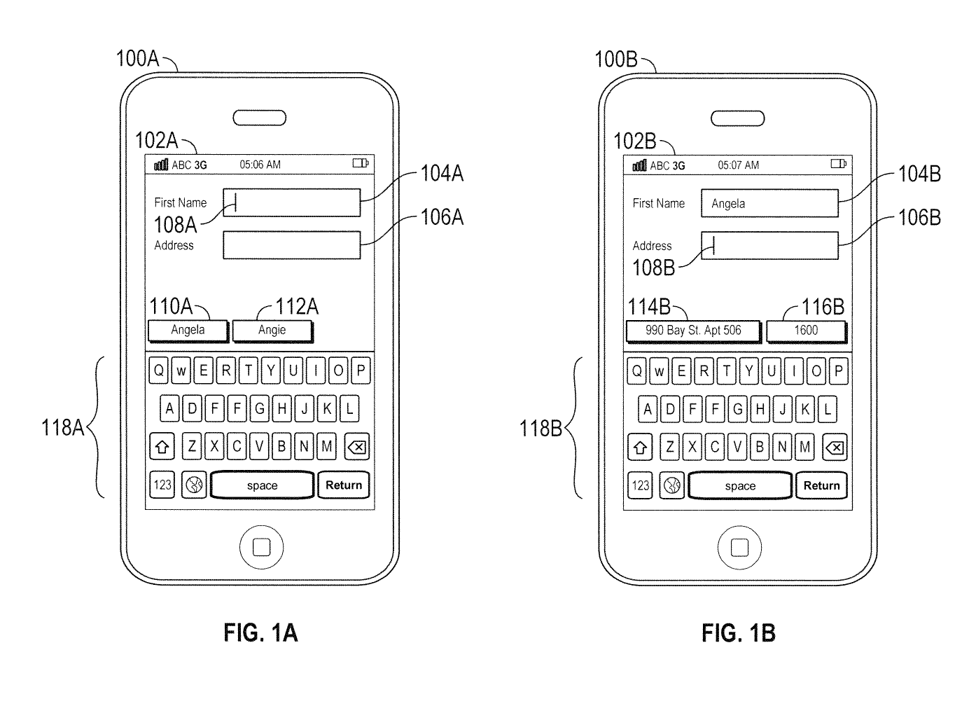

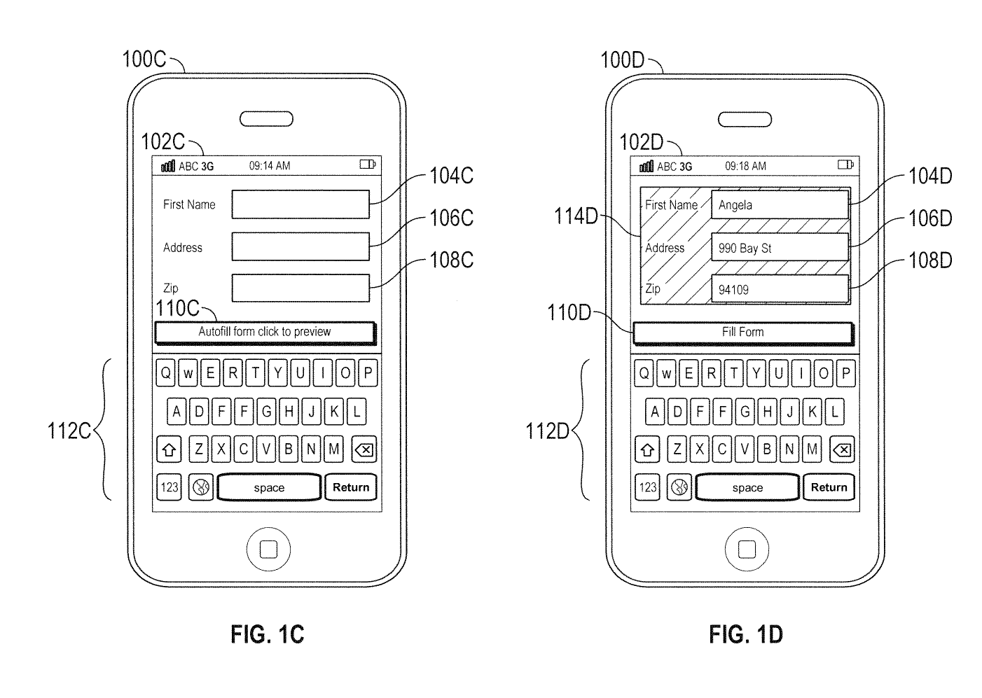

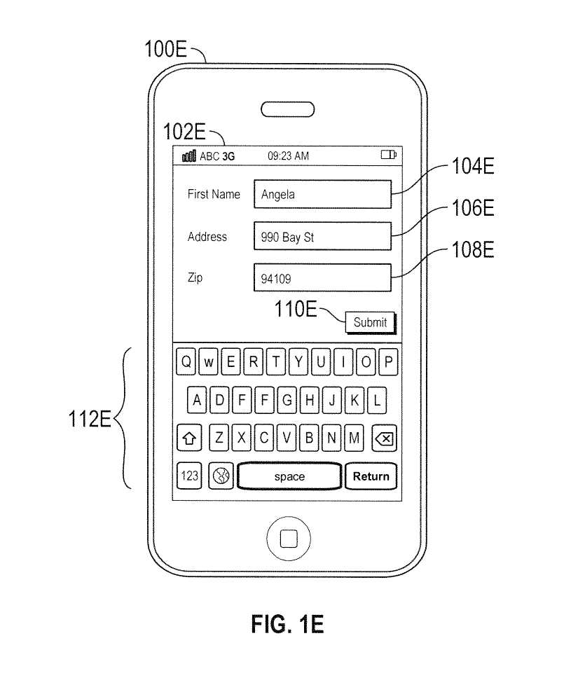

FIGS. 1A-1E illustrate mobile device(s) 100A, 100B, 100C, 100D, and 100E implementing an autofill user interface. The illustrated mobile device(s) 100A, 100B, 100C, 100D, and 100E may be the same mobile device, at different times, or different mobile devices. In some examples, the illustrated mobile devices 100A and 100B are the same mobile device at different times, and the illustrated mobile devices 100C, 100D, and 100E are the same mobile device at different times. The illustrated mobile devices 100A and 100B represent a different mobile device from the illustrated mobile devices 100C, 100D, and 100E.

As shown in FIG. 1A, the mobile device 100A includes a screen 102A, which may be a touchscreen. The screen displays a page from an application (e.g., a web browser application, an online banking application, an online shopping application, etc.). The page includes a first name input box 104A and an address input box 106A. The user has placed a cursor 108A in the first name input box 104A, for example, by touching the first name input box, causing the on-screen keyboard 118A and the autofill buttons 110A and 112A to be displayed. The text in the autofill buttons 110A and 112A, “Angela” and “Angie,” respectively, may correspond to values for the first name field stored in the application, which resides in the local memory of the mobile device 100A. The user may either type text in the first name input box 104A using the on-screen keyboard 118A or select one of the autofill buttons 110A or 112A.

In some examples, the autofill buttons 110A and 112A may be presented on the screen overlaying the page (e.g., a webpage in a web browser or a page in an online banking application or online shopping application) but not within the page. As a result, the text in the autofill buttons 110A and 112A is not transmitted to a server associated with the page being displayed until one of the autofill buttons 110A or 112A is selected. (However, in some examples, autofill suggestion(s) may be generated via an autofill server. Alternatively, autofill suggestions may be generated based on information stored and processed locally at the mobile device 100A.) As shown, the autofill buttons 110A and 112A appear adjacent to the on-screen keyboard 118A. However, in an alternative implementation, the autofill buttons 110A and 112A may appear within the first name input box 104A.

In situations in which the systems discussed here collect personal information about users, or may make use of personal information, the users may be provided with an opportunity to control whether programs or features collect user information (e.g., information about a user's name, mailing address, telphone number, email address, etc.), or to control whether and/or how to receive content from the autofill server that may be more relevant to the user. Thus, the user may have control over how information is collected about the user and used by the autofill server.

As shown in FIG. 1B, the user has selected the autofill button 110A, having the text “Angela,” of FIG. 1A. In response, the mobile device 100A is transitioned into the mobile device 100B by adjusting the screen 102A to the display the information on screen 102B, which may be a touchscreen. Specifically, the first name input box 104B now displays the text “Angela” from the autofill button H OA. The cursor 108B is moved into the address input box 106B. The on-screen keyboard 118B continues to be presented for the user to be able to type any information into the address input box 106B. In addition, new autofill buttons 114E and 116B, corresponding to autofill suggestions for the address input box 106B, are displayed. The text in the autofill buttons 114B and 116B, “990 Bay St Apt 506” and “1600,” respectively, may correspond to values for the address field stored in the application. In some cases, the leftmost autofill button 114B corresponds to the address which is associated with the most recently selected autofill button 110A “Angela” of FIG. 1A. In other words, the memory of the mobile device 100A/100B may store that the address for “Angela” is “990 Bay St Apt 506,” and the address for “Angie” is “1600.” As a result of the leftmost autofill button corresponding to the most likely to be selected autofill suggestion, the user may be able to autocomplete a form on a page in an application with minimal movement of his/her finger or stylus.

Similar to the autofill buttons 110A and 112A, the autofill buttons 114B and 116B may be presented overlaying the page rather than within the page. As a result, the text within the autofill buttons 114B and 116B may not be transmitted to the server associated with the page being displayed until one of the autofill buttons 114B or 116B is selected. Also, as shown, the autofill buttons 114B and 116B appear adjacent to the on-screen keyboard 118B. However, in an alternative implementation, the autofill buttons 114B and 116B may appear within the address input box 106B. As shown in FIGS. 1A-1B, the autofill buttons 110A, 112A, 114B, and 116B indicating autofill suggestions may be presented adjacent to the keypad 118A or 118B displayed on the screen 102A or 102B.

FIG. 1C illustrates a mobile device 100C having a screen 102C, which may be a touchscreen. The screen 102C illustrates a page that includes a first name input box 104C, an address input box 106C, and a zip input box 108C. The page may be a page in a web browser or a page in another application, for example, an online shopping application or a social networking application. An “autofill form click to preview” button 110C overlays the page and is not included in the page. Similarly, the on screen keyboard 112C may overlay the page and not be included in the page. The user may select the “autofill form click to preview” button 110C, for example, by touching the “autofill form click to preview” button 110C. After selection of the “autofill form click to preview” button 110C, the mobile device 100C may transition to the mobile device 100D.

As illustrated in FIG. 1D, the mobile device 100D has a screen 102D, which may be a touchscreen. The screen 102D illustrates a page that includes a first name input box 104D, an address input box 106D, and a zip input box 108D, similar to the input boxes 104C, 106C, and 108C of FIG. 1C. As shown, the autofill suggestion “Angela” overlays the first name input box 104D, the autofill suggestion “990 Bay St” overlays the address input box 106D, and the autofill suggestion “94109” overlays the zip input box 108D. Instead of being presented within the page, the autofill suggestions for the input boxes 104D, 106D, and 108D overlay the corresponding input boxes 104D, 106D, and 108D and are not included in the page, as indicated by the shaded region 114D, which may be presented, on a mobile device with a color screen, as highlighted or in a different color than other portions of the screen 102. Advantageously, as a result of the autofill suggestions not being included in the page, the text of the autofill suggestions is not transmitted to a web server hosting the page until the text of the autofill suggestions is accepted by the user of the mobile device 100D. The text of the autofill suggestions corresponding to the input boxes 104D, 106D, and 108D may be stored locally at the mobile device 100D and may be generated based on information stored at the mobile device 100D or based on information stored at a server associated with a service provider of the mobile device. The service provider may be a telephone company, a developer of an operating system, a developer of a web browser or other application, etc. In order to accept the autofill suggestions, the user may select the fill form button 110D, for example, by touching the fill form button 110D. Alternatively, the user may reject the autofill suggestions, by typing different text into one or more of the input boxes 104D, 106D, or 108D using the on screen keyboard 112D. After selection of the fill form button 110D, the mobile device 100D may transition to the mobile device 100E.

As illustrated in FIG. 1E, the mobile device 100E includes a screen 102E, which may be a touchscreen. The screen 102E illustrates a page that includes a first name input box 104E, an address input box 106E, and a zip input box 108E, similar to the input boxes 104C, 106C, and 108C of FIG. 1C and the input boxes 104D, 106D, and 108D of FIG. 1D. The autofill suggestions “Angela,” “990 Bay St,” and “94109” are transmitted from the local memory of the mobile device 100E to a web server hosting the page and displayed in the page within the corresponding input boxes 104E, 106E, and 108E. A submit button 110E is provided in the page for the user to finalize the entries in the input boxes 104E, 106E, and 108E and to authorize the web server to process the entries (e.g., to mail a package to the user or to store the user's name and address in conjunction with an account). An on screen keyboard 112E is also provided to allow the user to edit the entries in the input boxes 104E, 106E, and 108E.

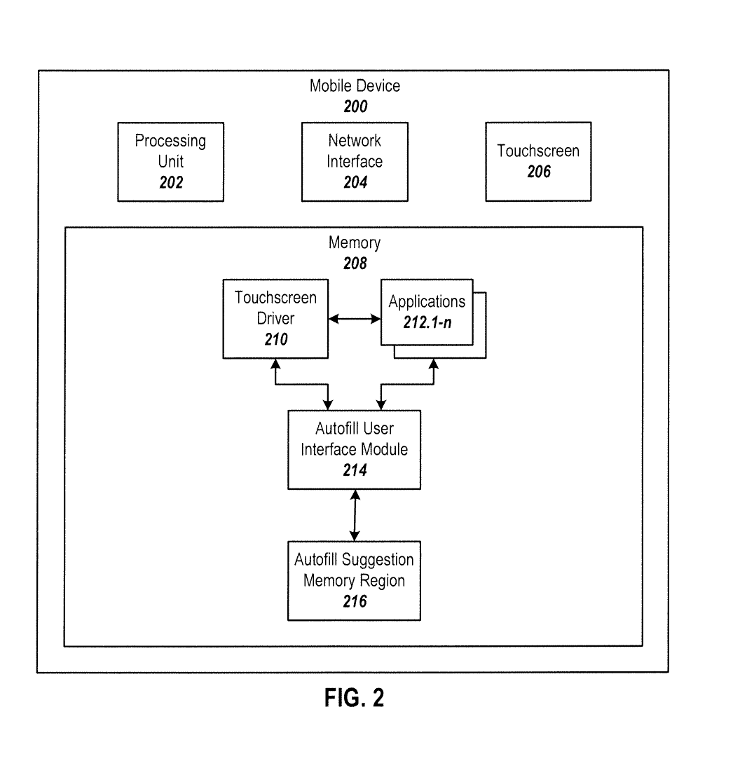

FIG. 2 illustrates, as a block diagram, an example of a mobile device 200 for implementing an autofill user interface. The mobile device 200 may correspond to one or more of the mobile devices 100A, 100B, 100C, 100D, or 100E. The mobile device 200 may be a mobile phone, a personal digital assistant (PDA), an electronic music player, a tablet computer, a laptop computer, etc.

As shown, the mobile device 200 includes a processing unit 202, a network interface 204, a touchscreen 206, and a memory 208. The processing unit 202 includes one or more processors. The processing unit may include a central processing unit (CPU), a graphics processing unit (GPU), or any other processing unit. The processing unit 202 is configured to execute computer instructions that are stored in a computer-readable medium, for example, the memory 208. The network interface 204 is configured to allow the mobile device 200 to transmit and receive data in a network, e.g., the Internet, a cellular network, a local area network (LAN), a wide area network (WAN), a WiFi network, etc. The network interface 204 may include one or more network interface controllers (NICs). The touchscreen 206 is configured to display information, for example page(s) and information overlaying page(s) from the mobile device 200 to a user of the mobile device 200. For example, the touchscreen may correspond to one or more of the screens 102A, 102B, 102C, 102D, or 102E. The touchscreen 206 is also configured to receive input from the user, for example, by the user touching the touchscreen 206 with one or more fingers. The touchscreen 206 may be a component of the mobile device 200 or may be coupled to the mobile device 200 and reside externally to the mobile device 200. The touchscreen 206 may be a single touchscreen or a multi-touchscreen.

The memory 208 stores data and/or instructions. The memory 208 may be one or more of a cache unit, a storage unit, an internal memory unit, or an external memory unit. As illustrated, the memory 208 includes a touchscreen driver 210, application(s) 212.1-n, an autofill user interface module 214, and an autofill suggestion memory region 216.

The touchscreen driver 210 is coupled with the touchscreen 206. The touchscreen driver 210 is configured to transmit data to the touchscreen 206 for presentation at the touchscreen 206 and to receive input from the touchscreen 206 for processing using the processing unit 202 and the memory 208. For example, one or more applications 212.1-n may process data from the touchscreen driver. The application(s) 212.1-n may include any application(s) stored at the mobile device 200. For instance, the application(s) 212.1-n may include a web browser, a shopping application, a social networking application, a banking application, etc.

The autofill suggestion memory region 208 stores autofill suggestions that may be provided by the mobile device 200. Example autofill suggestions are illustrated in FIGS. 1A-1E and may include suggestions for a first name, for instance, “Angela” or Angie,” suggestions for an address, for instance, “990 Bay St” or “990 Bay St Apt 506,” or suggestions for a zip, for instance, “94109.”

The autofill user interface module 214 includes code which, when executed by the processing unit 202, causes the processing unit 202 to provide an autofill user interface, for example, as illustrated in FIGS. 1A-1E, via the touchscreen 206. In some implementations, when executing the autofill user interface module 214, the processing unit 202 presents a page via the touchscreen 206, the page includes one or more input boxes for entering input responsive to one or more prompts. The processing unit 202 presents one or more autofill suggestions for a first input box from the one or more input boxes. The one or more autofill suggestions are presented in a position overlaying the page. The page does not include the one or more autofill suggestions and the one or more autofill suggestions are not transmitted to a web server hosting the page until the autofill suggestions are accepted by the user. In some implementations, the autofill suggestions reside locally at the mobile device 200, in the autofill suggestion memory region 216, and are not provided to any machine external to the mobile device 200 until the autofill suggestions are accepted by the user. Alternatively, the autofill suggestions are provided to the mobile device 200 from a machine different from the web server hosting the page.

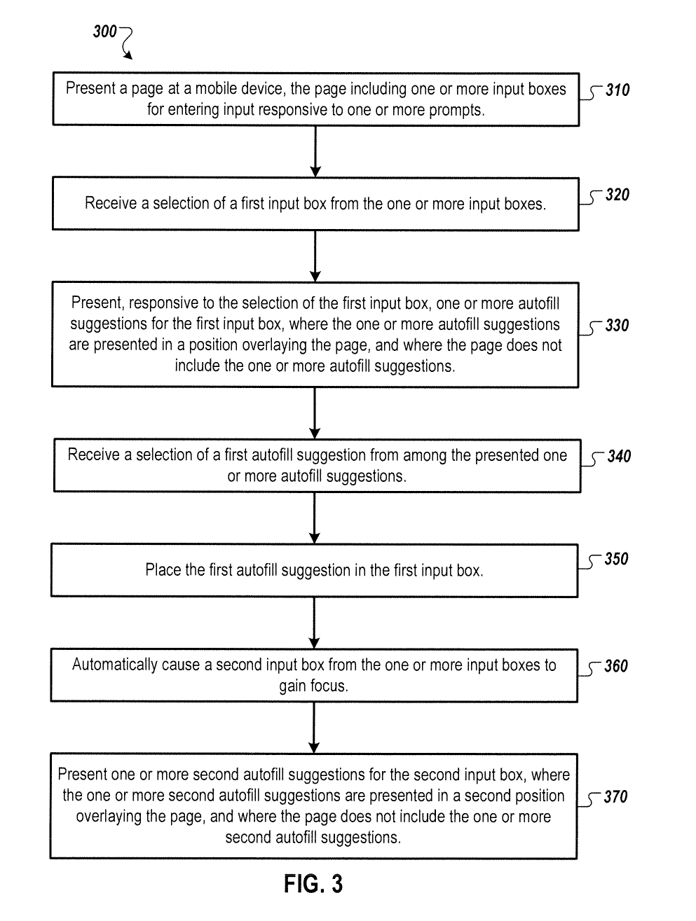

FIG. 3 illustrates an example process 300 by which an autofill user interface for a mobile device may be implemented.

The process 300 begins at step 310, where a mobile device (e.g., mobile device 200, via operation of the autofill user interface module 214) presents a page (e.g., a webpage presented via a web browser or a page in an application other than a browser) at the mobile device at a touchscreen (e.g., touchscreen 206) of the mobile device. The page includes one or more input boxes (e.g., input boxes 104A and 106A) for entering inputs responsive to one or more prompts (e.g., the prompts “First Name” and “Address” illustrated in FIG. 1A).

In step 320, the mobile device receives, via the touchscreen, a selection of a first input box from the one or more input box. For example, the user may touch, using a finger or a stylus, the first input box.

In step 330, the mobile device presents at the touchscreen, responsive to the selection of the first input box, one or more autofill suggestions (e.g., autofill buttons 110A and 112A) for the first input box. The one or more autofill suggestions are presented in a position overlaying the page, rather than within the page. The page does not include the one or more autofill suggestions. As a result of the page not including the one or more autofill suggestions, the text of the one or more autofill suggestions is not transmitted to a web server hosting the page. According to some implementations, the mobile device stores one or more user profiles (e.g., in the autofill suggestion memory region 216) and the presented one or more autofill suggestions correspond to information stored in the one or more profiles.

As described herein in conjunction with steps 320-330, the autofill suggestion(s) are presented responsive to the selection of the first input box. However, in some implementations, autofill suggestion(s) may be presented automatically upon loading the page, without having the user select an input box, or upon the user pressing a button (e.g., “autofill form click to preview” button 110C of FIG. 1C). In some implementations, step 320 may be skipped and step 330 may be implemented in response to an input or a stimulus different from the selection of the first input box (for example, the selection of the “autofill form click to preview” button 110C).

In step 340, the mobile device receives a selection of a first autofill suggestion from among the presented one or more autofill suggestions. For example, the user may touch the first autofill suggestion or press a button (e.g., autofill button 110A or another button for accepting the first autofill suggestion on the touchscreen 206) indicating acceptance of the first autofill suggestion.

In step 350, the mobile device places the first autofill suggestion (e.g., the text “Angela”) into the first input box (e.g., input box 104B).

In step 360, the mobile device automatically causes a second input box (e.g., input box 106B) from the one or more input boxes to gain focus. As used herein, a user interface element, for example, an input box, is said to gain focus if the user interface element is displayed on a display device (e.g., the touchscreen 206) and is set to receive user input unless the user selects another user interface element to receive the input.

In step 370, the mobile device presents, via the touchscreen, one or more second autofill suggestions (e.g., autofill buttons 114B and 116B) for the second input box. The one or more second autofill suggestions are presented in a second position overlaying the page, which may be the same as or different from the position overlaying the page for the autofill suggestions for the first input box. The page does not include the one or more second autofill suggestions. According to some implementations, the mobile device stores one or more user profiles (e.g., in the autofill suggestion memory region 216) and the presented one or more second autofill suggestions correspond to information stored in the one or more profiles.

In some examples, the second autofill suggestion(s) are presented in a particular order. The particular order is determined based on the selected first autofill suggestion for the first input box. For example, the topmost or leftmost second autofill suggestion may be associated with the same user profile as the selected first autofill suggestion. For example, a computer may store a first name “Greg” associated with an address “28 State Street” and a first name “Kate” associated with an address “1870 Beacon Street.” If the autofill “Greg” is selected for the first name input box, the autofill suggestion “28 State Street” may be presented to the left of or above the autofill suggestion “1870 Beacon Street” for the address input box. After step 370, the process 300 ends.

As described above, the steps 310-370 of the process 300 are carried out in a predetermined order and in series. However, the steps 310-370 of the process 300 may be carried out in any order. In some implementations, two or more of the steps 310-350 of the process 300 are carried out in parallel. Also, in some cases, one or more of the steps 310-350 may be skipped or may not be implemented. For example, in some cases, step 320 may be skipped. In some cases, steps 340-370 may not be implemented.

As described herein in conjunction with the process 300, the autofill suggestion(s) for the first input box are presented before the second autofill suggestion(s) for the second input box. However, in some implementations, the second autofill suggestion(s) for the second input box may be presented simultaneously with presenting the autofill suggestion(s) for the first input box. In some implementations, the same user input (e.g., selecting the “autofill form click to preview” button 110C and the “fill form” button 110D) may be used to select the autofill suggestion for the first input box, the second autofill suggestion for the second input box, and/or an additional autofill suggestion for an additional input box. For instance, as illustrated in FIGS. 1C-1E, the same input is used for selecting autofill suggestions for three input boxes for the first name, address, and zip.

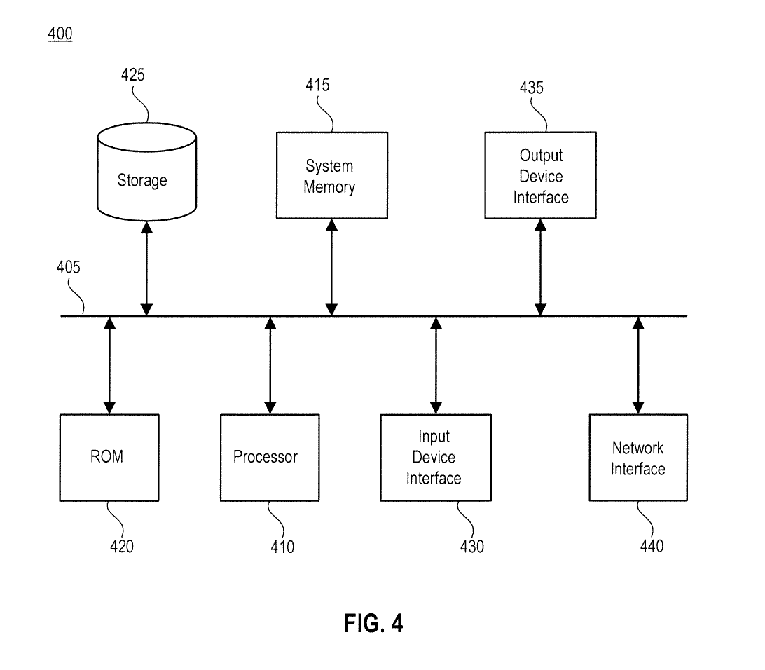

FIG. 4 conceptually illustrates an electronic system 400 with which some implementations of the subject technology are implemented. For example, the mobile device 200 may be implemented using the arrangement of the electronic system 400. The electronic system 400 can be a computer (e.g., a mobile phone, PDA), or any other sort of electronic device. Such an electronic system includes various types of computer readable media and interfaces for various other types of computer readable media. Electronic system 400 includes a bus 405, processing unit(s) 410, a system memory 415, a read-only memory 420, a permanent storage device 425, an input device interface 430, an output device interface 435, and a network interface 440.

The bus 405 collectively represents all system, peripheral, and chipset buses that communicatively connect the numerous internal devices of the electronic system 400. For instance, the bus 405 communicatively connects the processing unit(s) 410 with the read-only memory 420, the system memory 415, and the permanent storage device 425.

From these various memory units, the processing unit(s) 410 retrieves instructions to execute and data to process in order to execute the processes of the subject technology. The processing unit(s) can be a single processor or a multi-core processor in different implementations.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some implementations of the subject technology use a mass-storage device (for example a magnetic or optical disk and its corresponding disk drive) as the permanent storage device 425.

Other implementations use a removable storage device (for example a floppy disk, flash drive, and its corresponding disk drive) as the permanent storage device 425. Like the permanent storage device 425, the system memory 415 is a read-and-write memory device. However, unlike storage device 425, the system memory 415 is a volatile read-and-write memory, such a random access memory. The system memory 415 stores some of the instructions and data that the processor needs at runtime. In some implementations, the processes of the subject technology are stored in the system memory 415, the permanent storage device 425, or the read-only memory 420. For example, the various memory units include instructions for providing an autofill user interface in accordance with some implementations. From these various memory units, the processing unit(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interfaces 435 enables, for example, the display of images generated by the electronic system 400. Output devices used with output device interface 435 include, for example, printers and display devices, for example cathode ray tubes (CRT) or liquid crystal displays (LCD). Some implementations include devices for example a touch screen that functions as both input and output devices.

Finally, as shown in FIG. 4, bus 405 also couples electronic system 400 to a network (not shown) through a network interface 440. In this manner, the electronic system 400 can be a part of a network of computers (for example a local area network (LAN), a wide area network (WAN), or an Intranet, or a network of networks, for example the Internet. Any or all components of electronic system 400 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A method, comprising:
presenting a page at a computing device, the page comprising a first input box and a second input box for entering input responsive to one or more prompts;
receiving a first user interaction with the first input box;
presenting, in response to the first user interaction, a first graphical user element in a position overlaying the page, the first graphical user element indicating an autofill suggestion that corresponds to first entry values for the first input box, the position of the first graphical user element being excluded from the page;
receiving a second user interaction with the first graphical user element excluded from the page;
presenting, in response to the second user interaction with the first graphical user element excluded from the page, 1) the first entry values within the first input box and 2) a second graphical user element in a second position overlaying the page, the second graphical user element indicating a second autofill suggestion that corresponds to second entry values for a second input box, the second autofill suggestion being suggested based on the first entry values within the first input box, the second position of the second graphical user element being excluded from the page;
receiving a third user interaction with the second graphical user element excluded from the page; and
presenting, in response to the third user interaction with the second graphical user element excluded from the page, the second entry values within the second input box.

2-4. (canceled)

5. The method of claim 1, wherein the computing device stores one or more user profiles, and wherein the autofill suggestion corresponds to information stored in the one or more user profiles.

6. (canceled)

7. The method of claim 1, further comprising:
presenting a second page at the computing device, the second page comprising a particular input box for entering input responsive to one or more prompts;
receiving a particular user interaction with the particular input box;
presenting, in response to the particular user interaction, a particular graphical user element in a position overlaying the second page, the particular graphical user element indicating a particular autofill suggestion that corresponds to entry values for the particular input box, the position of the particular graphical user element being excluded from the second page;
receiving a second particular user interaction with the particular graphical user element excluded from the page;
presenting, in response to the second particular user interaction with the particular graphical user element, a third particular graphical user element in a second position overlaying the second page, wherein the second page excludes the third particular graphical user element, the presented third particular graphical user element indicating a second particular autofill suggestion that corresponds to second entry values for a second particular input box;
receiving a fourth particular user interaction with the third particular graphical user element;
transmitting, in response to the fourth particular user interaction, the second autofill suggestion to a server associated with the second page for input of the second entry values into the page;
presenting, in response to transmitted second autofill suggestion, the second entry values within the second particular input box; and
receiving, via a second particular graphical user element, an input for accepting the autofill suggestion for the particular input box and for accepting the second autofill suggestion for the second particular input box.

8. (canceled)

9. (canceled)

10. A non-transitory computer-readable medium storing instructions which, when executed by one or more processors, cause the one or more processors to implement a method, the method comprising:
presenting a page on a user interface of a client computing device, the page comprising a first input box and a second input box for entering input responsive to one or more prompts;
receiving a first user interaction with the first input box;
presenting, in response to the first user interaction, a first graphical user element in a position overlaying the page, the first graphical user element indicating an autofill suggestion that corresponds to first entry values for the first input box, the position of the first graphical user element being excluded from the page;
receiving a second user interaction with the first graphical user element excluded from the page;
presenting, in response to the second user interaction with the first graphical user element, 1) the first entry values within the first input box and 2), a second graphical user element in a second position overlaying the page, the second graphical user element indicating a second autofill suggestion that corresponds to second entry values for a second input box, the second autofill suggestion being suggested based on the first entry values within the first input box, the second position of the second graphical user element being excluded from the page;
receiving a third user interaction with the second graphical user element excluded from the page; and
presenting, in response to the third user interaction with the second graphical user element excluded from the page, the second entry values within the second input box.

11. (canceled)

12. (canceled)

13. The non-transitory computer-readable medium of claim 10, wherein the computer stores one or more user profiles, and wherein the autofill suggestion corresponds to information stored in the one or more user profiles.

14-17. (canceled)

18. A computing device comprising:
a touchscreen;
one or more processors; and
a memory comprising instructions which, when executed by the one or more processors, cause the one or more processors to-perform operations comprising:
presenting a page at the touchscreen, the page comprising a first input box and a second input box for entering input responsive to one or more prompts;
receiving a first user interaction with the first input box;
presenting, in response to the first user interaction, a first graphical user element in a position overlaying the page, the first graphical user element indicating an autofill suggestion that corresponds to entry values for the first input box, the position of the first graphical user element being excluded from the page;
receiving, via the touchscreen, a second user interaction with the first graphical user element excluded from the page;
presenting, in response to the second user interaction with the first graphical user element, 1) the entry values within the first input box and 2) a second graphical user element in a second position overlaying the page, the second graphical user element indicating a second autofill suggestion that corresponds to second entry values for a second input box, the second autofill suggestion being suggested based on the entry values within the first input box, the second position of the second graphical user element being excluded from the page;
receiving a third user interaction with the second graphical user element excluded from the page; and
presenting, in response to the third user interaction with the second graphical user element excluded from the page, the second entry values within the second input box.

19. (canceled)

20. The computing device of claim 18, wherein the computing device stores one or more user profiles, and wherein the autofill suggestion corresponds to information stored in the one or more user profiles.

21. (canceled)

22. The method of claim 7, further comprising a prioritized listing of autofill suggestions for the second particular input box based on the second particular user interaction with the particular input box, the second particular autofill suggestion corresponding to one of the autofill suggestions in the prioritized listing.

23. The method of claim 7, wherein the second particular autofill suggestion for the second particular input box is presented after presenting the particular autofill suggestion for the particular input box.

24. The method of claim 7, wherein the particular autofill suggestion for the particular input box and the second particular autofill suggestion for the second particular input box are associated with a same user.

25. The method of claim 1, wherein the position of the first graphical user element is within the first input box.

26. The method of claim 1, further comprising:
providing for display an on-screen keyboard on the page, the position of the presented first graphical user element being adjacent to the on-screen keyboard.

27. The method of claim 1, further comprising:
presenting, in response to the first user interaction, a third graphical user element in a third position overlaying the page, the third position of the third graphical user element being adjacent to the position of the presented first graphical user element, the presented third graphical user element indicating a third autofill suggestion that corresponds to third entry values for the first input box, the page excluding the third graphical user element.

28-33. (canceled)

34. The method of claim 1, wherein presenting the entry values within the first input box further comprises:
presenting for display a shaded region overlaying a portion of the page, the shaded region including the entry values, the portion of the page including the first input box and a second portion of the portion of the page, the second portion of the page not including an input box.
